(19) United States
(12) Patent Application Publication
(10) Pub. No.: US 2004/0058301 A1
(43) Pub. Date: Mar. 25, 2004

(54) Method for enhancing reading comprehension

(76) Inventors: Arthur M. Glenberg, McFarland, WI (US); Michael P. Kaschak, Tallahassee, FL (US); Tiana Gutierrez, Cottage Grove, WI (US); Sandra Japuntich, Madison, WI (US); Joel R. Levin, Tucson, AZ (US)

Correspondence Address: Bennett J Berson, Quarles & Brady LLP, P O Box 2113, Madison, WI, 53701-2113, US

(21) Appl. No.: 10/607,660

(22) Filed: Jun. 27, 2003

Related U.S. Application Data
(60) Provisional application No. 60/392,722, filed on Jun. 28, 2002.

(51) Int. Cl. G09B 19/00; G09B 5/00

(52) U.S. Cl. 434/156; 434/169

(57) ABSTRACT

The present invention relates to methods for enhancing an individual subject's comprehension of unfamiliar written matter. The inventors here disclose that a suitable method involves physical manipulation of objects relevant to the written matter, such that the manipulation increases indexing by the subject of written words to the objects represented by the words. Increased indexing, which can be accomplished as described herein, facilitates the derivation of meaning from the written words and comprehension increases.

### CROSS-REFERENCE TO RELATED APPLICATIONS

This application claims the benefit of U.S. Provisional Patent Application No. 60/32,722, filed Jun. 28, 2002 which is incorporated by reference herein as if set forth in its entirety.

### STATEMENT REGARDING FEDERALLY SPONSORED RESEARCH OR DEVELOPMENT

Not applicable.

### BACKGROUND OF THE INVENTION

The Indexical Hypothesis is an “embodied” (e.g., Glenberg, 1997) account of how language becomes meaningful. As such, it is in contrast to most theories of linguistic meaning that are based on amodal, abstract, and arbitrary symbols (AAA symbols). A brief overview of these theories sets the stage for the Indexical Hypothesis. One example of a theory making use of AAA symbols is the semantic network (e.g., Collins & Loftus, 1975). Consider the node representing the concept “chair.” This node is abstract in that it is meant to be the meaning of all chairs, including kitchen chairs, armchairs, and beanbag chairs. The node is amodal in that the same node is contacted whether the chair is seen, talked about, or sat in. Finally, the node is arbitrary in that there is no reason why one node rather than another is used to represent the concept “chair.” In fact, because the nodes are arbitrarily related to the concept, meaning is given not by the node itself, but by its relations to other nodes such as the furniture node and the object node. While differing in details, the vast majority of current cognitive theories of meaning use AAA symbols. Thus, theories using propositional representations (e.g., Kintsch, 1988) use AAA symbols in that each element in a proposition is equivalent to a AAA symbols. Similarly, most schema theories (e.g., Schank & Abelson, 1977), connectionist theories (e.g., Masson, 1995), and theories using high dimensional spaces (e.g., Burgess & Lund, 1997; Landauer & Dumais, 1997) make use of AAA symbols.

There are several reasons why AAA symbols are predominant. First, these symbols are easy to implement in formal computer and mathematical models. Second, they are absolutely necessary to theories that subscribe to a basic tenet of modern cognitive psychology and artificial intelligence, namely, that thinking is nothing more than the manipulation of AAA symbols by rules (e.g., Newell, 1980). If that is the case, then thinking can be adequately modeled (in fact, produced) by computer simulations. In contrast, if thinking requires perceptual information, then AAA symbols that intentionally strip away all perceptual information and computers that can describe perceptual information but do not literally have any perceptual apparati, cannot think.

Whereas AAA symbols are undeniably popular, there are also several reasons why they are undeniably inadequate. The foremost is the symbol grounding problem (Glenberg & Robertson, 2000; Harnad, 1990; Searle, 1980), namely that AAA symbols cannot by themselves generate meaning; instead the symbols must be grounded. Harnad's version of Searle's Chinese Room argument makes the case cogently. Harnad has us imagine that we have landed at a foreign airport equipped solely with a dictionary written in the foreign language we do not speak. Upon encountering a sign written in the language, we try to understand the first word by looking it up in the dictionary. Unfortunately, the definition is solely in terms of words in the foreign language that are to us, prototypical AAA symbols. Undeterred, we look up the first word in the definition to find that it is defined in terms of other AAA symbols. Of course, no matter how many words we look up in the dictionary, we will never understand any of them, let alone the meaning of the sign. Yet, that is exactly what cognitive theories employing AAA symbols expect of us. For example, the nodes in a semantic network are defined solely in terms of their relations to other nodes, just as the words in the dictionary are defined solely in terms of the other words in the dictionary.

One might suppose that theories making use of AAA symbols have a simple recourse: The AAA symbols are grounded by associating them with perceptual information. Unfortunately, there are four problems with this approach. First, none of the theories actually proposes how this could be done, nor do any of the theories actually make use of perceptual information in accounting for meaning. Second, if perceptual information were to play a major role in producing meaning, then the power of AAA symbols would be severely eroded in that thinking would no longer be due to the manipulation of AAA symbols by rules that can be implemented regardless of the perceptual apparatus (e.g., on a computer). Third, Putnam (1981, and as reviewed in Lakoff, 1987) has proven that when starting with a system of AAA symbols, it is impossible to find the one correct grounding. That is, sets of AAA symbols are the equivalent of a series of algebraic equations in that the numerals, Xs, and Ys in the equation are exactly AAA symbols. A system of equations can be applied to an infinite variety of events in the world. For example, an equation relating speed and time to distance traveled by a car will apply to that particular car, any other car, and in fact it will apply to an infinity of moving objects that have the same relations among speed, time, and distance as the particular car. Similarly, because a set of AAA symbols (e.g., a set of propositions) is equivalent to a set of equations, it will apply to an infinite variety of situations—that is, all those situations that have the same set of relations. Consequently, if we thought in terms of AAA symbols, it would be impossible to know what we were thinking about because those same symbols could apply to an infinite number of situations. Fourth, modern neuroscience (e.g., Edelman, 1992) has failed to find anything like AAA symbols in the brain. Rather, perceptual afference and motor feedback seem to be intimately involved in all levels of coding.

The Indexical Hypothesis, like other embodied theories of cognition (Barsalou, 1999; Lakoff, 1987), does not use AAA symbols. Instead it proposes that meaning arises from the interaction of the body's perceptual and action systems with the environment. The AAA symbols of language, that is, words, become meaningful through three processes. First, words and phrases are indexed to objects in the environment or to perceptual symbols; second, affordances are derived from the objects; third, the affordances are combined, or “meshed,” as directed by syntax, to produce a coherent simulation. Consider, for example, how we understand a sentence such as, “Art kicked the chair.” The first process is that words and phrases, such as “Art” and “the chair” are indexed. Thus, if the sentence were uttered while gesturing to a particular chair, the comprehender would index or map the phrase to that chair (e.g., Chambers, Tanenhaus, Eberhard, & Filip, 2002). If the sentence were spoken outside of the context including the chair, or if the sentence were read, the comprehender would index the word to a perceptual symbol. Unlike AAA symbols, perceptual symbols (Barsalou, 1999) are not amodal and arbitrary. Instead, they are patterns of neural activity abstracted from perceptual experience by selective attention. That is, these symbols are grounded by their intimate relation with perceptual experience. Thus, in attempting to understand the sentence about Art, “Art” is indexed to a perceptual symbol of a particular person, or perhaps if one has a pet fish named “Art,” to the fish. The second process is deriving affordances from the indexed perceptual symbols. Affordances (e.g., Gibson, 1979) are possibilities for interaction determined by the body and the objects in the environment. Thus, a chair affords sitting for an adult human, but not for an adult fish. Some chairs also afford hiding under for a small child or a mouse, but not for an adult. That is, affordances determine how the object can be used by a being with a particular kind of body. Finally, affordances are meshed, as directed by the syntax of the sentence. The process of mesh takes into account how affordances can combine into smooth, coherent action, rather than being a simple associative process. Syntax directs the combination in that the affordances of Art (the adult) must be meshed with those of the chair, so that Art kicks the chair rather than, say, the chair kicking Art. The sentence is understood to the extent that the mesh process results in a coherent simulation of the event described by the sentence. Language understanding can be derailed by any of these three processes. For example, if a comprehender happened to index “Art” to her pet fish, then the sentence would be seen as nonsensical; chairs do not afford kicking for fish. In short, comprehension results from simulating the actions described by the language using perceptual and action information, not the words or other AAA symbols.

Three lines of research provide empirical support for the processes specified by the Indexical Hypothesis. The first line of research investigates perceptual symbols in conceptual tasks such as feature listing. Barsalou, Solomon, and Wu (1999) demonstrated that variability in the features listed for a concept and variability in the order in which features are listed are controlled by the perceptual simulation being engaged rather than by an abstract, unchanging semantic representation. Using a property verification task, Pecher, Zeelenberg, and Barsalou (2003) observed a priming effect having a perceptual basis. Participants responded whether or not an object (e.g., a lawn mower) has a particular property (e.g., loud). Pecher et al. found that if the perceptual dimension probed on the next trial (e.g., leaves-rustle) was the same as that probed on the previous trial, then responding was faster than if the perceptual dimension probed on the previous trial was different (e.g., leaves-green).

A second line of research investigates sentence understanding. For example, Zwaan and his associates (Stanfield & Zwaan, 2001) asked participants to verify that a picture (e.g., of a pencil) depicted an object mentioned in a sentence (e.g., “The pencil is in a cup.”) They found that pictures that matched the orientation of the object implied by the sentence (a pencil depicted vertically in this case) were responded to faster than pictures of the object in an orientation that mismatched orientation implied by the sentence (a pencil depicted horizontally). As another example, Glenberg and Kaschak (2002) asked each participant to judge the sensibility of sentences such as “You gave Andy the pizza” or “Andy gave you the pizza” by moving the hand from a start button to a Yes button. Location of the Yes button determined if the action of responding “yes” was consistent with the direction implied by the sentence (away from the body for “You gave Andy the pizza”) or inconsistent (toward the body). Responding was faster when the hand movement was consistent with the action implied by the sentence than when it was inconsistent. Both sets of results strongly imply that language understanding requires consideration of the perceptual and action characteristics of the situation described.

The third line of research demonstrates facilitatory effects of action paired with language. It is this line of research that anticipates the effects we report herein. If language understanding requires indexing of words to objects in the environment or to perceptual symbols, then forcing listeners and readers to complete that process should facilitate comprehension, memory, and application. Consistent with this prediction is a now-standard finding in the memory literature: memory for a list of tasks (e.g., scratch your ear, break the toothpick, etc.) is greatly enhanced if the task is actually performed in addition to reading the description of the task (Nilsson et al., 2000). A finding of Noice and Noice (2001) demonstrates a related effect with discourse. Novice actors were more successful at memorizing dialog when scripted actions were included than when the actors were simply told to read and memorize the dialog. Analogous work with young children has supported the beneficial consequences of activity and imagined activity on associative-learning performance (e.g., Bender & Levin, 1976; Varley, Levin, Severson, & Wolff, 1974; Wolff & Levin, 1972). Finally, consistent with the earlier findings of Lesgold, Levin, and their colleagues (e.g., Lesgold, DeGood, & Levin, 1977; Lesgold, Levin, Shrimron, & Guttmann, 1975), Rubman and Waters (2000) demonstrated a positive effect of activity/manipulation with third-grade and six-grade students in a text-learning context. Children read a short text and were queried as to whether the text contained any contradictions. Half of the children read the text twice. The others read the text, and then used a story board to depict it. The children in that latter condition were more successful at detecting errors. Related research and outcomes, based on children's drawing activity, have recently been reported by van Meter (2001).

Despite the intensive efforts directed toward understanding the mechanisms for developing skills for improving reading comprehension, further understanding and additional methods for improving comprehension are still sought in the art.

### BRIEF SUMMARY OF THE INVENTION

In keeping with the Indexical Hypothesis, the present invention relates to methods for enhancing an individual subject's comprehension of unfamiliar spoken or written matter. The inventors here disclose that a suitable method involves physical manipulation of objects relevant to the spoken or written matter, such that the manipulation increases indexing by the subject of spoken or written words to the objects represented by the words. Increased indexing, which can be accomplished as described infra, facilitates the derivation of meaning from the spoken or written words, and increases comprehension.

In one aspect the invention is summarized in that a subject practicing a method of the invention has access to a physical representation of a scenario described in a text and access to a plurality of physical objects representing actors or objects in the scenario.

In one such method, the subject reads the text and manipulates the relevant physical object or objects in the physical representation to act out a plurality of sentences that describe an action by an actor or an action upon an object in the scenario (hereinafter, “critical sentences”), such that a comprehension benefit is realized. In a preferred method, the subject manipulates one or more objects for each critical sentence in the text.

In a related method, the subject has access, in sequential trials spaced apart in time, to a plurality of scenarios and scenario-relevant objects and the method step is performed for each scenario, such that the subject acquires experience with the physical manipulation step in a plurality of contexts, thereby reinforcing the notion that the comprehension benefit is context-independent.

In yet another related method, which can be practiced by a subject having sufficient experience with either or both of the foregoing methods to have transferred the comprehension benefit of the physical manipulation step, the subject reads the text and imagines manipulating physical objects without actually manipulating objects, while nevertheless realizing a transferred comprehension benefit from the prior physical manipulation experience.

A physical object manipulation step is a fundamental aspect of comprehension improvement using the methods of the invention, at least in the initial stages (see discussion of imagined manipulation by experienced subjects, supra). Moreover, it is also important that the physical objects used in the method have realistic attributes (which can include but are not limited to size, shape, and weight) relative to one another and to the physical representation of the scenario. By way of example, if a first object in a scenario is lifted by a second object, the first and second objects should be represented in such a way as to convey that the lifting is possible. Likewise, if in a scenario an object is to be placed in a room, the room in the physical representation should not be smaller than the placed object.

The methods of the invention can be practiced under supervision of an instructor who can direct the subject to practice the relevant method step or steps in the course of an ongoing effort to improve reading comprehension. It can be advantageous to practice the invention with supervision, as the instructor can judge the subject's progress and moderate the pace of progress from physical manipulation to imagined manipulation.

In a related aspect, the tools of the method, namely the physical representation of the scenario(s) and the plurality of scenario-relevant objects, in combination with the text, can be provided as a kit which can optionally include an instructor's guide for directing preferred practice of the inventive methods. It is specifically envisioned that the text and the optional instructor's guide can be provided in any medium, including but not limited to an electronic medium, such as computer readable text or text embodied within an executable computer program. The text provided in electronic medium can be configured to provide such cues, signals, feedback and analysis as would be provided by an instructor. Provision of the text in an electronic medium does not obviate the use of physical objects for manipulation in the method.

The invention can be employed in a variety of settings having distinct goals. For inexperienced readers, who may, e.g., be young (e.g., first or second grade level) or developmentally-delayed, the methods can be an alternative to methods for learning to read that lack perceptual symbols wherein written words remain abstract symbols only tangentially related to actual objects. In such methods, reading can be a pointless word calling exercise.

The methods of the invention need not concern simple scenarios as would be appropriate for new readers. The skilled artisan in possession of this disclosure will appreciate the applicability of the methods to many teaching situations, particularly in that the invention provides a framework for increasing comprehension of any concept that is foreign to the subject, whether that concept embraces unfamiliar language, subject matter, technical detail or the like. It will likewise be apparent that the sophistication of the scenario and the language used in the methods can be varied to match the sophistication of the subject or subjects practicing the invention.

It will therefore be appreciated that the accompanying Detailed Description describes preferred embodiments that demonstrate the concept of the invention, but that the invention is not limited to using that concept to improve comprehension among inexperienced readers.

### BRIEF DESCRIPTION OF THE SEVERAL VIEWS OF THE DRAWINGS

Not applicable.

### DETAILED DESCRIPTION OF THE INVENTION

### Overview of the Experiments

We used a manipulation procedure to ensure indexing of written words. First- and second-grade children read short texts describing characters and actions in three toy scenarios, a farm, a house, and a gas station/garage. The objects and characters (e.g., for the farm scenario, a barn, a tractor, assorted animals, etc.) were on display in front of the child. After reading each of five selected sentences, the child manipulated the objects to correspond to the sentence. To do this, the child must index the words and phrases to objects, and must use the syntax of the sentence to guide manipulation. After reading the text, the toy scenario was covered and the child was engaged in distracting conversation for two minutes. This distraction was followed by a series of memory and application tests.

In Experiment 1, children were randomly assigned to three conditions in which different types of instruction/practice were provided over several sessions: Manipulation, Read (where children read the texts and observed the scenarios but did not manipulate the toys), and no-practice Control. For children in the Manipulation condition, a fading procedure was used to gradually withdraw the amount of support given to indexing before a transfer test was administered in which children read from a new scenario without benefit of manipulation. Experiment 2 differed from Experiment 1 in several ways. First, there was more practice with manipulation before the strategy-maintenance transfer test was administered. Second, the children in a Reread condition reread each of the critical sentences to help control for the amount of time that children in the Manipulate condition spent attending to the text. Third, in addition to the memory test of Experiment 1, an application test was included. The application test required the children to draw inferences from what they had read. Experiment 3 introduced another change intended to give children practice indexing without explicit manipulation. Children in the Imagined Manipulation condition first practiced physical manipulation, as in the previous experiments. Then, these children were instructed in how to imagine manipulating the objects without physically manipulating them (and the children in the Reread condition were instructed to reread the critical sentences silently).

### Experiment 1

Several questions guided the design of the experiment. First, would very young readers be helped by manipulation? Second, would any benefits be moderated by reading ability? Third, would children learn to index as a general strategy such that benefits of manipulation training would transfer to situations in which the children did not physically manipulate? Students participated in this experiment during the fall of their second-grade year. Each child in the Manipulate and Read conditions participated in six sessions, whereas children in the Control condition participated in only the first and sixth sessions. The first session was used to obtain a number of measures of students' reading ability. Sessions 2-5 involved training in manipulation and then fading. Session 6 was a test of transfer or strategy maintenance.

### Method

Participants. Parental permission to participate in the experiment was obtained for 35 children beginning the second grade at a middle socioeconomic status public school in Madison, Wis. Three children were eliminated on the basis of extreme difficulty reading a practice text and low scores on the Woodcock Test of Word Identification. Their raw scores were 5, 13, and 18, whereas the remaining children had scores ranging from 20 to 58 with a mean of 34.5 and a standard deviation of 9.6. In addition, because of absences data were unavailable for three children for Session 6, the maintenance session.

Children were assigned to conditions using the following scheme. First, children were grouped by gender. Second, within each gender, children were ranked by performance on the standardized measures of reading given during the first session, and triplets of children with successive ranks were formed. Third, children within a triplet were randomly assigned so that one participated in the Manipulate condition, one in the Read condition, and one in the Control condition. In total, there were 11, 11, and 10 children in the Manipulate, Read, and Control conditions, respectively. In all sessions, the interventions and testing were individually administered.

Materials. The scenario toys were commercially available and consisted of a Farm scene (including a barn, corral, tractor, several animals, hay, etc.), a House scene (including a house with several rooms and props, a mother, a father, a baby, etc.), and a Garage scene (including a garage with elevator, ramps, store, gas pumps, car wash, tow truck, etc.). For each scenario we wrote five short texts of 7-9 sentences each. A text for the Farm scene is given in Table 1. For each text, we selected five sentences that described actions, and these sentences were followed by “green lights.” The green lights were hand-drawn representations of traffic lights with a green light. They were the signal to the child to manipulate the toys in the scenario.

TABLE 1
Example Text (from Farm Scenario) and Spatial Inference Questions
Title: Breakfast on the farm

Ben needs to feed the animals.
He pushes the hay down the hole.*
The goat eats the hay.*
Ben gets eggs from the chicken.*
He puts the eggs in the cart.*
He gives the pumpkins to the pig.*
All the animals are happy now.

Spatial inference questions (Experiments 2 and 3)

At the beginning of the story, is Ben on the same floor as the goat?
When Ben is giving the pig the pumpkins, can he see the sheep?
Was the cart next to Ben when he got the eggs?
*Sentence followed by a green light.

Procedure. The procedure is described for the Manipulate condition first. Data were collected from each child in six sessions. There were approximately two sessions a week. All sessions were videotaped for later scoring.

Session 1: The child was tested on the Gathercole and Baddeley (1996) Non-Word Repetition Test, the Woodcock (1998) Test of Word Identification, and the Woodcock (1998) Test of Word Attack Skills (non-word reading). A test of indexing was also given, but because of ceiling effects these data will not be reported.

Session 2: The child was introduced to one of three toy scenes (Farm, Gas Station, or House). Choice of scenario was counterbalanced as best as possible given the sample size. In the introduction, the tester named each object for the child, and each child was required to manipulate the object (e.g., “This is the horse. Put the horse into the corral.”). In addition, the child read (with the experimenter's help) a practice text with green light sentences. Following a green light sentence, the child was instructed to manipulate the objects in the scene to correspond to the sentence. The child then read two stories referring to the scenario. Choice of stories and their order were counterbalanced. Within each story, five sentences were followed by green lights. Following each story, the toy scene was covered so that it was not visible, and the child was distracted for two minutes with conversation. Then, the child was asked to recall all of the information in the story. Only general prompts were given, such as “What happened next?” Finally, the child was given a cued recall test for each of the five green light sentences. The cue was the first part of the sentence, and the child was asked to recall the rest of the sentence.

Session 3: This session was identical to Session 2, except that a different scenario was used.

Session 4: The child read one (new) story from each scenario. There were no green light sentences (and so no overt manipulation) although the toy scenes were visible while the child read. The point of this session was to determine whether the child would continue to index (as indicated by both looking at the toy scenes and enhanced recall scores compared to the Control condition) when no manipulation was required.

Session 5: The child read one (new) story from each scenario. The toy scenes were not visible during reading and there were no green light sentences. The point of this session was to determine whether the child would index to perceptual symbols (as indicated by recall scores) in the absence of the visible toy scenes.

Session 6: The child was introduced to the third scenario by naming each object and having the child manipulate the object. Then the child read two stories from the third scenario with no manipulation. Following each story the free and cued recall measures were administered.

Children in the Read condition were treated exactly like the children in the Manipulate condition except that there were no green light sentences during Sessions 2 and 3. Children in the Control condition participated in Sessions 1 and 6 during the same times of the semester as did children in the other conditions.

### Results and Discussion

All statistical analyses were conducted with a Type I error probability set at 0.05. The data of greatest interest are presented in Table 2. For both free and cued recall, we judged whether or not the main idea of each of the critical sentences was recalled. Because of the similarity of procedures, the results from Sessions 2 and 3 were combined for statistical analysis. Occasionally, in this and the following experiments, video-recorded responses for a particular story were uninterpretable because participants spoke too softly. In these few instances, proportions were estimated by averaging over all relevant stories. For example, if data were missing for one Session 2 story, then the combined Session 2 and 3 score would be based on the three other stories equally weighted. The proportion of main ideas free recalled from the critical sentences was much greater for the Manipulate condition (0.76) than for the Read condition (0.51), F(1, 20)=17.76, MSe=0.02, p<0.001, Cohen's d=1.80. There was a similar effect for cued recall, in that performance in the Manipulate condition (0.90) exceeded that in the Read condition (0.78), F(1, 20)=11.68, MSe=0.01, p=0.003, d=1.46. Clearly, manipulation greatly enhances memory for the text.

TABLE 2
Data from Experiment 1

| | | | | | Main- |
|---|---|---|---|---|---|
| | Training | | Fading | | tenance |
| Group | Session 2 | Session 3 | Session 4 | Session 5 | Session 6 |

Proportion of critical sentences free recalled

| | | | | | |
|---|---|---|---|---|---|
| Manipulate | .76 | .75 | .55 | .46 | .54 |
| Read | .49 | .51 | .58 | .64 | .61 |
| Control | — | — | — | — | .40 |

Proportion of critical sentences cued recall

| | | | | | |
|---|---|---|---|---|---|
| Manipulate | .94 | .87 | .79 | .66 | .80 |
| Read | .77 | .80 | .75 | .79 | .77 |
| Control | — | — | — | — | .65 |

Fading began in Session 4. Each child read one text from each of the scenarios introduced in Sessions 2 and 3, but there were no green light sentences to signal explicit manipulation. As may be seen from Table 1, the difference between the groups vanished, F<1 for both free and cued recall. Apparently, children in the Manipulate condition had not learned anything that was readily maintained.

In Session 5 the toy scenarios were not visible while the children read. Surprisingly (given the outcomes from the previous sessions), children in the Read condition outperformed their Manipulate counterparts on both performance measures: free recall, F(1, 20)=7.62, MSe=0.02, p=0.01, d=-1.18; cued recall, F(1, 20)=7.32, MSe=0.01, p=0.01, d=-1.15. Given other conflicting data from this experiment and the following two experiments, there is no reasonable explanation for these findings.

In Session 6, the children were introduced to a new scenario, and there were no green light sentences. No obvious benefits of prior manipulation practice were apparent. In particular, including the no-practice Control condition in an analysis with the two practice conditions (Manipulate and Read) yielded no statistical differences among conditions: free recall, F(2, 26)=2.59, MSe=0.04, p=0.09; cued recall, F(2, 26)=2.41, MSe=0.03, p=0.11. On the other hand, when the Control condition's data were included in an analysis of children's Session 2 performance (i.e., following only one previous testing experience for children in all conditions and where manipulation was permitted): (1) differences among the three conditions emerged for both free recall, F(2, 27)=6.66, MSe=0.05, p=0.004, and cued recall, F(2, 28)=11.45, MSe=0.02, p<0.001; and (2) Fisher LSD comparisons revealed that children in the Manipulate condition remembered more sentences, for both free and cued recall (0.76 and 0.94, respectively), than either Read participants (0.49 and 0.77, respective ds=1.19 and 1.26, and as was previously reported in the combined Session 2-Session 3 analysis) or children in the Control condition (0.40 and 0.65, respective ds=1.56 and 2.13), with no mean differences between Read and Control participants. Noteworthy is that even though students in the Control condition had (by the time of Session 6) several weeks more instruction in reading than children in the Manipulate condition at Session 2, the latter's memory for the texts was much greater than the former's.

The results from Experiment 1 are clear. As we would expect from other work showing benefits of action associated with verbal information (e.g., Nilsson et al., 2000; Noice & Noice, 2001; Rubman & Waters, 2000; van Meter, 2001; Wolff & Levin, 1972), manipulating text referents after reading a sentence greatly enhances memory, even for very young readers. On the other hand, there was no hint of any internalized maintenance of the manipulation strategy. That is, when children in the Manipulate condition were no longer permitted explicit manipulation, they showed no statistically significant advantage compared to children in either the Read (starting in Session 4) or Control (in Session 6) conditions. Apparently the children in the Manipulate group either did not learn: (a) a general skill of indexing; or (b) how to apply that skill on their own.

### Experiment 2

Experiment 2 was designed to replicate and extend the major results of Experiment 1. It was also designed to test a proposal as to why there was so little Session 6 strategy maintenance in Experiment 1: Two days of practice on manipulating (Sessions 2 and 3) may have been insufficient to teach indexing as a skill that children could apply on their own. Thus, in Experiment 2 children in the Manipulate condition manipulated the toy scenarios for twice as long (Sessions 2-5) before the maintenance test in Session 6. In addition, there were three other important changes from Experiment 1. First, the participants were children starting the second semester of their first grade in school (instead of second graders, as in Experiment 1). Second, beginning in Session 4, the cued recall test was dropped in favor of a spatial inference test designed to measure application of knowledge gleaned from the text. Third, children in the Reread condition were instructed to reread green light sentences to better control for the amount of time children in the Manipulate condition spent attending to each of the critical sentences.

### Method

Participants. Parental permission to participate in the experiment was obtained for 29 children beginning the second semester of the first grade at the same school as Experiment 1. (One child was eliminated for throwing toys at the experimenter!) Children were assigned to conditions using the same scheme as for Experiment 1. In total, there were eight, nine, and 11 children in the Manipulate, Reread, and Control conditions, respectively.

Materials. The materials were identical to those used for Experiment 1 except for the spatial inference test questions used in Sessions 4-6. For each text, we wrote three Yes/No questions that were difficult or impossible to answer on the basis of the text alone and on the basis of the toy scenario alone. Instead, the correct answer could be derived by integrating the verbal and scenario information. Examples are given in Table 1. Note that for the first question, the text does not specify Ben's (the Farmer's) location. However, there is a hole in the hayloft directly above the goat's pen through which a toy bale of hay can be dropped to the goat. Thus the correct answer for this question is “No.” The spatial inference questions were not written to probe exclusively knowledge derived from green light (manipulated) sentences. Hence, they provide a more general measure of text understanding than free or cued recall of the green light sentences.

After answering each spatial inference question, the child was asked to justify his or her answer. The justification measure was included for two reasons. First, the proportion correct determined by Yes/No scoring can be greatly affected by guessing (i.e., the “chance” probability here is 0.5). Second, we wanted to give children the opportunity to justify answers based on creative reasoning. For example, a child might say that Ben first walked to the barn and climbed into the hayloft before pushing the hay down the hole. Thus, in the child's mind, Ben and the goat were on the ground floor at the beginning of the story, and the answer to the question should be “Yes.” In cases such as this, even though the Yes/No answer received a score of 0, the child was awarded credit for the justification as explained next.

The participants' justifications were evaluated by three people working together. One person was the “cuer.” This person cued the videotape to the location at which the child was beginning to answer the spatial inference question. The cuing was done out of sight and hearing of the other two people, the “scorers.” Thus, the scorers remained blind to the condition. Each scorer evaluated the justifications independently of the other scorer using the following scheme. The justification was given a score of “A” if the Yes/No answer was correct and the child referred to the particulars of the text in justifying the Yes/No answer. A score of “B” was used if the child answered the Yes/No question incorrectly, but the child was able to provide a justification that referred to the particulars of the text or a creative extension of the text (e.g., that Ben had been on the first floor of the barn before climbing to the hayloft). A score of “C” was used if the child provided no justification, if the justification did not refer to the particulars of the text (e.g., “Farmers are never on the same floor as goats”), or if the scorers could not understand the justification. Note that a score of “C” means “unjustified,” regardless of the correctness of the Yes/No answer. Any disagreements between the two scorers (which occurred on less than 10% of the justifications) were settled by consensus after the scorers recorded their initial evaluations. Less than 5% of the justifications were classified as “B.” Hence analyses were conducted on a combined justification score, the sum of the proportions of “A” and “B” scores.

Procedure. Except in one respect, the procedure for Sessions 1, 2, and 3 were identical to those of Experiment 1. The one difference was that children in the Reread condition saw the same green lights following sentences as did children in the Manipulate condition. For children in the Reread condition, the green light signaled that a sentence was to be reread aloud.

Sessions 4 and 5 were identical to Sessions 2 and 3 except that the spatial inference questions replaced the cued recall test. Session 6, the strategy maintenance session, was identical to Session 6 in Experiment 1 except, once again, the spatial inference test was administered instead of the cued recall test.

### Results and Discussion

The data of major interest are presented in Table 3. The data from Sessions 2 and 3 were analyzed together. The mean proportion of green light sentences freely recalled by children in the Manipulate condition (0.63) exceeded that of children in the Reread condition (0.38), F(1, 15)=10.58, MSe=0.03, p=0.005, d=1.58. There was a similar effect for cued recall, F(1, 15)=8.52, MSe=0.02, p=0.01, d=1.42, in which the children in the Manipulate condition (0.89) outperformed those in the Reread condition (0.67). Thus, the beneficial effects of manipulation can be found for first graders (this experiment) as well as second graders (Experiment 1).

TABLE 3
Data from Experiment 2

| | | | | | Main- |
|---|---|---|---|---|---|
| | Training Sessions | | | | tenance |
| Group | Session 2 | Session 3 | Session 4 | Session 5 | Session 6 |

Proportion of critical sentences free
recalled (and cued recall)

| | | | | | |
|---|---|---|---|---|---|
| Manipulate | .55 (.86) | .69 (.91) | .65 | .68 | .29 |
| Reread | .33 (.63) | .43 (.70) | .32 | .39 | .39 |
| Control | — | — | — | — | .44 |

Proportion of critical sentences correct on
spatial inference questions

| | | | | | |
|---|---|---|---|---|---|
| Manipulate | — | — | .84 | .85 | .79 |
| Reread | — | — | .80 | .57 | .65 |
| Control | — | — | — | — | .79 |

Justification of spatial inference questions

| | | | | | |
|---|---|---|---|---|---|
| Manipulate | — | — | .78 | .79 | .73 |
| Reread | — | — | .52 | .48 | .66 |
| Control | — | — | — | — | .67 |

The data from Sessions 4 and 5 were also analyzed together. For the free recall test, children in the Manipulate condition recalled more green light sentences (0.66) than did children in the Reread condition (0.36), F(1, 15)=15.46, MSe=0.03, p=0.001, d=1.91. Application, as measured by proportion correct on the dichotomously (Yes/No) scored spatial inference test was somewhat better for the children in the Manipulate condition (0.84) than for the children in the Reread condition (0.69), although this effect was statistically significant only on the basis of a directional test, F(1, 15)=3.66, MSe=0.03, p=0.04 (one-tailed), d=0.93. In addition, the difference was statistically significant for the spatial inference justification score, F(1, 15)=6.05, MSe=0.06, p=0.03; d=1.20, with children in the Manipulation condition averaging 0.78 and those in the Reread condition averaging 0.49. These data indicate that manipulation enhances inference-demanding application in addition to simple memory.

Session 6 was the strategy maintenance session in that a new scenario was introduced and displayed in front of all children, but there were no green light sentences and no instructions to manipulate the toys. As in Experiment 1, there were no significant differences among the three conditions (Manipulation, Reread, Control) for free recall, F<1, proportion correct on the dichotomously scored spatial inference test, F(2, 25)=1.17, MSe=0.05, p=0.33, or the justification scores, F<1.

As in Experiment 1, we also included Control participants' free recall data in an analysis of children's Session 2 performance (representing all participants' second test experience with the experimenters and where manipulation was permitted). Although the descriptive statistics again favored Manipulate participants (means of 0.55, 0.33, and 0.44 for Manipulate, Reread, and Control, respectively), in contrast to the results of Experiment 1 differences among the three conditions were not statistically significant, F(2, 25)=1.62, MSe=0.06, p=0.22.

Thus, as in Experiment 1, we have demonstrated that manipulation is very effective when engaged in, but it does not seem to result in a general strategy of indexing that carries over in the absence of direct manipulation, even when manipulation is practiced for four sessions. Nonetheless, the experiment did produce a couple of new pieces of valuable information. First, we uncovered very large effects of manipulation on first-grade readers' free recall even when manipulation was contrasted with a reread strategy. Second, we demonstrated that the beneficial effects of manipulation extend to passage-derived application (as indexed by spatial inference) as well as memory.

### Experiment 3

There are three apparent problems with the procedures used in Experiments 1 and 2 that may have precluded strategy maintenance in Session 6. First, although manipulation ensures indexing, we did not provide the children with any particular skills or practice that would result in indexing without physical manipulation. Following Wolff and Levin's (1972) approach, however, in Experiment 3 we introduced a new component to the procedure, Imagined Manipulation (i.e., students picturing their would-be manipulations in their heads), which might provide just such a skill. After practicing physical manipulation, children in the Imagined Manipulation condition were given practice in imagining how they would manipulate the toy scenario. Then, instead of physical manipulation, the green lights signaled that the child should engage in imagined manipulation. In the Reread condition, the green lights first signaled that the child should reread a sentence aloud. Then, at the point when children in the Imagined Manipulation condition were introduced to imagined manipulation, children in the Reread condition were taught that the green lights were now a signal to reread sentences silently.

A second reason why the procedures used in Experiment 1 and 2 may have been inadequate is that the benefits of indexing were never explicitly pointed out to the children. That is, they received no explicit metacognitive instruction regarding indexing, whereas work on metacognition as applied to strategy monitoring clearly demonstrates the benefits of this sort of instruction (e.g., Duffy, 2002; Ghatala, Levin, Pressley, & Goodwin, 1986; Ghatala, Levin, Pressley, & Lodico, 1985). Consequently, at several points during the procedure, children in the Imagined Manipulation condition were explicitly told that manipulation and imagined manipulation were very beneficial for comprehension and memory, and children in the Reread condition were told the same for rereading aloud and rereading silently.

A third reason why the procedures used in Experiment 1 and 2 may not have revealed internalized strategy maintenance is that the conditions of the maintenance test may have had too little similarity to the training conditions to have invoked indexing. Consequently, in Session 3 of Experiment 3 we subdivided all participants into two conditions, Reminder and No Reminder. In the Reminder condition, children were introduced to a new scenario, but otherwise many of the cues and instructions remained the same. That is, green lights were present in the text and the children were reminded what the green lights signified. In the No Reminder condition, children were introduced to a new scenario and the green lights were present in the text. However, these children received no instruction or encouragement to apply any strategy.

### Method

Participants. Parental permission to participate in the experiment was obtained for 25 children in second semesters of the first and second grades at a low to middle socioeconomic status public school in Madison, Wis. Several other children were eliminated on the advice of teachers or parents who indicated either that the child was a nonreader or that because of behavior problems the child would be unlikely to be able to complete a session.

Children were assigned to conditions using a scheme similar to that of Experiments 1 and 2. First, children were grouped by gender. Within each gender grouping, the children were ordered by performance on text-reading subset of a standardized reading test used in the Madison Metropolitan School District, the Primary Language Arts Assessment (PLAA) test. The PLAA was used instead of the Woodcock test to reduce the amount of time children were taken out of the classroom. Successive groups of three children were randomly assigned so that two were assigned to the Imagined Manipulation condition and one to the Reread condition. Finally, half the children in each group were randomly assigned to the Reminder and half to the No Reminder condition. This assignment procedure led to totals of nine, nine, four, and three children in the Imagined Manipulation/Reminder condition, Imagined Manipulation/No Reminder condition, Reread/Reminder condition, and Reread/No Reminder condition, respectively. We did not expect much of a difference in transfer performance for the two Reread conditions and planned on collapsing the data for statistical analysis; hence the unequal assignment of children to groups. Also, because of limited student resources, we decided not to include a No-Practice control condition here.

Materials. The materials for the Farm and House scenarios were used in counterbalanced order so that approximately half the children in each group had each scenario for the maintenance test. In addition, several other sets of materials were written to provide practice in imagined manipulation and rereading silently and to encourage the use of these strategies.

Procedure. The procedure for the Imagined Manipulation condition will be described first. In Session 1, children were introduced to one of the scenarios and the green lights. However, there was more explicit instruction as to the helpfulness of the manipulation strategy. The child read the first story using physical manipulation. Then, the scenario toys were covered and the child was distracted for two minutes. The free recall and spatial inference tests followed the distraction. Next, the tester again noted the effectiveness of manipulation and introduced the idea of imagined manipulation as being equally effective. The following are verbatim instructions regarding imagined manipulation for children reading stories for the Farm scenario.

Suppose that you read, “The goat chased the horse into the corral.” If you were to act out the sentence, you would move the goat out of his pen and run to the horse. Then the horse would jump into the corral. Now, instead of acting out the sentence IMAGINE how you would move the goat to the horse and IMAGINE how the horse would jump into the corral. Don't really act out the sentence, but IMAGINE how you would move the toys to act out the sentence. Often it will help if you read the sentence and then LOOK at the toys to help you to IMAGINE how you would act out the sentence.

There is one other thing I would like you to do. When you finish reading the sentence, put your finger on the green light. Putting your finger on the light is a reminder to IMAGINE how you would move the toys to act out the sentence. So, read the sentence out loud, put your finger on the green light, look at the toys, and then IMAGINE acting out the sentence. Imagining will help you to remember the sentences and understand the story.

Children then practiced reading and imagining for two sentences. After each sentence, the tester asked the child to describe the image that (s)he had constructed. In particular, the child was prompted to describe steps intermediate between the information mentioned explicitly in the sentence. Finally, the child read a second story using the imagined manipulation strategy, and after distraction recalled the story and answered the spatial inference questions. The session ended with further discussion of the efficacy of imagined manipulation.

Session 2 consisted of the reading of two more stories using imagined manipulation. Each story was followed by both the free recall and spatial inference tests.

Session 3 differed for children in the Reminder and No Reminder conditions. For the Reminder condition, children were introduced to the characters in the new scenario and reminded about using the green lights as a signal to imagine manipulation. Then the children read and were tested on two stories from this scenario. For the No Reminder condition, children were introduced to the characters of the new scenario. Then, although the green lights were present, no mention was made of them, nor were children reminded about imagined manipulation. These children also read two stories from the new scenario.

For children in the two Reread conditions, the sessions were identical to those described above except that these children practiced rereading aloud or silently whenever children in the Imagined Manipulation condition practiced physical manipulation or imagined manipulation, respectively. Children in the Reread conditions were also told about the efficacy of rereading.

### Results

The results of major interest are presented in Table 4. Consider first performance on the first story in Session 1. The contrast of physical manipulation and rereading provides a replication of the conditions in the first two experiments. Compared to the children in the Reread condition, the children in the Manipulation condition recalled a greater proportion of the critical sentences, F(1, 23)=9.80, MSe=0.06, p=0.005, d=1.39, and answered correctly a greater proportion of the dichotomous spatial inference questions, F(1, 23)=4.32, MSe=0.03, p=0.05, d=0.81, although the effect was not statistically significant on the inference justification measure, F(1, 23)=1.93, MSe=0.07, p=0.18.

TABLE 4
Data From Experiment 3

| | | | | |
|---|---|---|---|---|
| | Day 1 | Day 1 | | |
| Group | Story 1 | Story 2 | Day 2 | Day 3 - Maintenance |

Proportion of critical sentences free recalled

| | | | | | |
|---|---|---|---|---|---|
| Imagined | .62^{a} | .66 | .66 | Reminder | .77 |
| Manipulation | | | | No Reminder | .68 |
| Reread | .29 | .31 | .24 | Reminder | .40 |
| | | | | No Reminder | .53 |

Proportion correcton spatial inference questions

| | | | | | |
|---|---|---|---|---|---|
| Imagined | .93^{a} | .83 | .89 | Reminder | .89 |
| Manipulation | | | | No Reminder | .83 |
| Reread | .76 | .72 | .64 | Reminder | .79 |
| | | | | No Reminder | .72 |

Justification of spatial inference questions

| | | | | | |
|---|---|---|---|---|---|
| Imagined | .67^{a} | .66 | .76 | Reminder | .76 |
| Manipulation | | | | No Reminder | .85 |
| Reread | .50 | .57 | .49 | Reminder | .59 |
| | | | | No Reminder | .65 |

^{a}For Story 1, this represents an actual Manipulation condition.

Performance on the second story in Session 1 and the two stories in Session 2 provide new information: a comparison of imagined manipulation with rereading silently. The data from these three stories were collapsed for analysis, and the analyses support the claim that imagined manipulation results in stronger memory and better application than rereading. Children in the Imagined Manipulation condition recalled a greater proportion of the critical sentences (0.66) than did children in the Reread condition (0.27), F(1, 23)=17.56, MSe=0.04, p<001, d=1.87; and children in the Imagined Manipulation condition answered correctly a greater proportion of the spatial inference questions (0.87) than did children in the Reread condition (0.67), F(1, 23)=11.29, MSe=0.02, p<0.005, d=1.50. In addition, children in the Imagined Manipulation condition provided somewhat stronger justifications (0.72) than did children in the Reread condition (0.52), F(1, 22)=3.80, MSe=0.05, p<0.05 (one-tailed), d=0.88.

Data from Session 3 determine whether or not there was strategy maintenance. In these analyses, there were two two-level experimental factors, Strategy (Imagined Manipulation, Reread) and Reminder (Yes, No), which were subjected to SAS Type III least squares factorial ANOVA procedures. For free recall of the green light sentences, there was only a main effect of Strategy, F(1, 21)=6.80, p=0.02, d=1.17, with children in the Imagined Manipulation condition recalling more than Reread participants (0.72 vs. 0.47, respectively). No statistically significant effects of Reminder were detected, either as a main effect (F<1) or in interaction with Strategy (F=1.28, p=0.27). In addition: (1) there were no statistically significant effects on the dichotomous spatial inference justification measure (all Fs<2.65, ps>0.12); and (2) on the spatial inference justification measure, Strategy was statistically significant on the basis of a directional test, F(1, 21)=4.01, p=0.03 (one-tailed), d=0.90, with no main effect of Reminder or an interaction between Strategy and Reminder, both Fs<1.

### Supplementary Analyses

Might any benefits of manipulation reflect an increase in fluency rather than indexing? That is, as the children become more familiar with the toys and their names (because of manipulation), they read the texts more fluently, overcome working memory limitations (e.g., Perfetti, 1985), and learn more. There are two pieces of data that speak against a simple fluency account. First, we tracked the number of miscues (that is, mispronunciations or failures to produce a word) and found that there were no differences among conditions in number of miscues in Sessions 1-3, all Fs<1. Second, for children in the Reread condition, we measured whether or not fluency increased on rereading aloud the green light sentences in the first story in Session 1. Although fluency increased on 89% of the reread sentences, as was noted in the Session 1 analyses, performance by children in the Reread condition was markedly inferior to that of children either physically (Story 1) or mentally (Story 2) manipulating the story objects.

Additional analyses were conducted both separately by and pooled within experiments, to determine whether children's initial reading ability (as reflected by their Woodcock and PLAA scores) predicted performance on the various outcome measures differentially under reading/rereading and manipulation conditions. Although previously reported benefits of manipulation were generally confirmed in these analyses, no interactions between children's initial reading ability and experimental condition were detected. That is, the regression of children's reading-task performance on their reading ability did not differ statistically by experimental condition (although this conclusion must be tempered by the relatively small sample sizes associated with these analyses).

### General Discussion

The present set of experiments extends the findings from earlier associative-learning research to suggest that both manipulation and imagined manipulation can greatly enhance young children's reading performance, as reflected by both their memory for what they have read and their ability to derive text-based inferences. That Manipulation-versus-Read/Reread differences were generally statistically significant here even with such small sample sizes and (relatively) unselected readers is particularly noteworthy. These differences were substantial in magnitude as well from a practical standpoint: Across experiments, the average percent of free-recall facilitation resulting from actual manipulation amounted to 78% (range=49% to 114%); and for cued recall, average percent facilitation (based on Experiments 1 and 2) was 24%. Improved recall of text information produced by imagined manipulation in Experiment 3 was even more impressive, amounting to a two-comparison (Sessions 1-2 and Session 3) average of 99%. Although not as consistently statistically significant, evidence of enhanced inference-demanding application produced by actual and imagined manipulation was also suggested. For example, in Experiment 2 Sessions 4 and 5 (those sessions that used manipulation and the inference test), the average percent facilitation in the justification scores was 59%. In Experiment 3 Session 1 (Story 1) and Session 2 (those stories that used Imagined Manipulation), the average percent facilitation in the dichotomous Yes/No scores was 30%. Nonetheless, additional research is needed to demonstrate that practice with imagined manipulation will lead to long-term maintenance and transfer in situations that are farther removed from the experimental situation. For example, research by Ghatala, Levin, and Pressley (e.g., Ghatala et al., 1985) strongly indicates that when it comes to learning-strategy maintenance, explicit performance-based feedback following experience with both effective and ineffective strategies is a critical element.

The Indexical Hypothesis provided the theoretical background that guided this research. Namely, meaning arises from indexing words to the objects and actions those words represent. Then, affordances, or how those objects can be manipulated are derived, and those affordances are combined as directed by the syntax of the sentence (cf. Kaschak & Glenberg, 2000). The Manipulation condition requires children to index the words to objects in order to manipulate them, and the condition requires the children to consider how to align the objects as directed by the syntax of the sentence. Thus, the manipulation condition guarantees meaningful comprehension as described by the Indexical Hypothesis.

Other approaches to language comprehension may also apply to our results. Here we consider two such approaches, one based on fluency, and one based on inference making and integration. Consider the fluency approach first. Among others, Perfetti (1985) and Rayner, Foorman, Perfetti, Pesetsky, and Seidenberg (2001) have emphasized the need to develop fluency in going from an orthographic code (the written words) to a phonological representation. We agree that this is a critical step in reading. In addition, as we discussed earlier, if derivation of the phonological representation is slow or results in a prosodically awkward (e.g., poorly accented) representation, then indexing will be difficult. Nonetheless, fluency by itself is insufficient to account for our data. That is, if the Manipulation condition generated better comprehension, memory, and application through enhanced fluency, then we would expect to see fewer miscues in this condition compared to the Reread condition. That was not the case. Furthermore, we documented enhanced fluency in the Reread condition when children reread sentences aloud for a second time (Experiments 2 and 3). Nonetheless, performance in this condition was markedly inferior to performance in the Manipulate condition.

A second approach that is more compatible with our data is that manipulation helps children to derive inferences necessary to construct integrated mental models and other high-level representations of the text (Mayer, 1989; Moreno & Mayer, 1999; Rubman & Waters, 2000). In fact, the meshed representations described by the Indexical Hypothesis can fairly be called embodied mental models. The Indexical Hypothesis adds to these other accounts several new ideas, however. First, mental models are constructed from perceptual symbols, rather than AAA symbols. Second, indexing words to specific objects or specific perceptual symbols (e.g., this particular barn with a hole in the hayloft rather than barns in general) is an important type of inference. Once a word is indexed, the affordances of the indexed object are a source of critically important information (e.g., the fact that the hole in the hayloft is large enough for the bale of hay to fit through it and that the hole is situated over the goat's pen so that the hay will fall into the pen). Third, the Indexical Hypothesis suggests why manipulation is a particularly effective strategy for early readers. Namely, manipulation ensures indexing.

In conclusion, we have demonstrated how an embodied approach to language comprehension, the Indexical Hypothesis, can be applied to enhance early reading performance. The hypothesis offers an approach to language comprehension that suggests a powerful faded teaching technique, manipulation and imagined manipulation. Furthermore, the hypothesis provides a new perspective on research demonstrating the importance of inference making and the construction of mental models. On this approach, inferences are not derived by a logical process working on AAA symbols. Instead, readers go beyond the words in a text by indexing them to particular objects (or perceptual symbols), deriving affordances, and combining those affordances as directed by syntax.

### REFERENCES

### (Each Reference Mentioned in the Application is Incorporated by Reference Herein as if set Forth in its Entirety)

Barsalou, L. W. (1999). Perceptual symbols systems. Behavioral & Brain Sciences, 22, 577-660.

Barsalou, L., Solomon, K. O., & Wu, L -L. (1999). Perceptual simulation in conceptual tasks. In M. K. Hiraga, C. Sinha, & S. Wilcox (Eds.), Cultural, typological, and psychological perspectives in cognitive linguistics: The proceedings of the 4th conference of the International Cognitive Linguistics Association (Vol. 3, 209-228). Amsterdam: John Benjamins.

Bender, B. G., & Levin, J. R. (1976). Motor activity, anticipated motor activity, and young children's associative learning. Child Development, 47, 560-562.

Burgess, C., & Lund, K. (1997). Modelling parsing constraints with high-dimensional context space. Language & Cognitive Processes, 12, 177-210.

Chambers, C. G., Tanenhaus, M. K., Eberhard, K. M., & Filip, H. (2002). Circumscribing referential domains during real-time language comprehension. Journal of Memory and Language, 47, 30-49.

Collins, A. M., & Loftus, E. F. (1975). A spreading-activation theory of semantic processing. Psychological Review, 82, 407-428.

Duffy, G. G. (2002). The case for direct explanation of strategies. In C. C. Block & M. Pressley (Eds.), Comprehension instruction (pp. 28-41). New York: The Guilford Press.

Edelman, G. M. (1992). Bright air, brilliant fire. New York: Penguin.

Ehri, L. C., Nunes, S., Stahl, S., & Willows, D. (2001). Systematic phonics instruction helps students learn to read: Evidence from the National Reading Panel's meta-analysis. Review of Educational Research, 71,393-447.

Gathercole, S. E., & Baddeley, A. D. (1996). The children's test of nonword repetition. London: Psychological Corporation.

Ghatala, E. S., Levin, J. R., Pressley, M., & Goodwin, D. (1986). A componential analysis of the effects of derived and supplied strategy utility information on children's strategy selections. Journal of Experimental Child Psychology, 41, 76-92.

Ghatala, E. S., Levin, J. R., Pressley, M., & Lodico, M. G. (1985). Training cognitive-strategy monitoring in children. American Educational Research Journal, 22, 199-215.

Gibson, J. J. (1979). The ecological approach to visual perception. New York: Houghton Mifflin.

Glenberg, A. M. (1997). What memory is for. Behavioral and Brain Sciences, 20, 1-55.

Glenberg, A. M., & Kaschak, M. P. (2002). Grounding language in action. Psychonomic Bulletin & Review, 9, 558-565.

Glenberg, A. M. & Robertson, D. A. (2000). Symbol grounding and meaning: A comparison of high-dimensional and embodied theories of meaning. Journal of Memory & Language, 43, pp 379-401.

Harnad, S. (1990). The symbol grounding problem. Physica D, 42, 335-346.

Kaschak, M. P., & Glenberg, A. M. (2000). Constructing meaning: The role of affordances and grammatical constructions in sentence comprehension. Journal of Memory and Language, 43, 508-529.

Kintsch, W. (1988). The role of knowledge in discourse comprehension: A construction-integration model. Psychological Review, 95, 163-182.

Lakoff, G. (1987). Women, fire, and dangerous things: What categories reveal about the mind. Chicago: University of Chicago Press.

Landauer, T. K., & Dumais, S. T. (1997). A solution to Plato's Problem: The latent semantic analysis theory of acquisition, induction, and representation of knowledge. Psychological Review, 104, 211-240.

Lesgold, A. M., DeGood, H., & Levin, J. R. (1977). Pictures and young children's prose learning: A supplementary report. Journal of Reading Behavior, 9, 353-360.

Lesgold, A. M., Levin, J. R., Shimron, J., & Guttman, J. (1975). Pictures and young children's learning from oral prose. Journal of Educational Psychology, 67, 636-642.Levin, J. R. (1986). Four cognitive principles of learning-strategy instruction. Educational Psychologist, 21, 3-17.

Masson, M. E. J. (1995). A distributed memory model of semantic priming. Journal of Experimental Psychology: Learning, Memory, and Cognition, 21, 3-23.

Masur, E. F. (1997). Maternal labeling of novel and familiar objects: Implications for children's development of lexical constraints. Journal of Child Language, 24, 427-439.

Mayer, R. E. (1989). Systematic thinking fostered by illustrations in scientific text. Journal of Educational Psychology, 81, 240-246.

Moreno, R., & Mayer, R. E. (1999). Cognitive principles of multimedia learning: The role of modality and contiguity. Journal of Educational Psychology, 91, 358-368.

Morris, C. D., Bransford, J. D., & Franks, J. J. (1977). Levels of processing versus transfer appropriate processing. Journal of Verbal Learning and Verbal Behavior, 16, 519-533.

Newell, A. (1980). Physical symbol systems. Cognitive Science, 4, 135-183.

Nilsson, L.-G., Nyberg, L. Klingberg, T., Aberg, C., Persson, J., & Roland, P. E. (2000). Activity in motor areas while remembering action events. Neuroreport, 11, 2199-2201.

Noice, H., & Noice, T. (2001). Learning dialogue with and without movement. Memory & Cognition, 29, 820-827.

Pecher, D. Zeelenberg, R., & Barsalou, L. W. (2003). Verifying properties from different modalities for concepts produces switching costs. Psychological Sciences, 14, 119-124.

Perfetti (1985).

Putnam, H. (1981). Reason, truth, and history. Cambridge: Cambridge University Press.

Rayner, K., Foorman, B. R., Perfetti, C. A., Pesetsky, D., & Seidenberg, M. S. (2001). How psychological science informs the reaching of reading. Psychological Science in the Public Interest, 2, 31-74.

Rubman, C. N., & Waters, H. S. (2000). A, B, seeing: The role of constructive processes in children's comprehension monitoring. Journal of Educational Psychology, 92, 503-514.

Schank, R. C., & Abelson, R. P. (1977). Scripts, plans, goals and understanding. An inquiry into human knowledge structures. Hillsdale, N.J.: Erlbaum.

Searle, J. R. (1980). Minds, brains and programs. Behavioral & Brain Sciences, 3, 417-424.

Stanfield, R. A., & Zwaan, R. A. (2001). The effect of implied orientation derived from verbal context on picture recognition. Psychological Science, 12, 153-156

Symons, S., McGoldrick, J. A., Snyder, B. L., & Pressley, M. (1990). Reading comprehension. In M. Pressley and Associates (Eds.), Cognitive strategy instruction that really improves children's academic performance (pp. 45-70). Cambridge, Mass.: Brookline.

Tulving, E., & Thomson, D. M. (1973). Encoding specificity and retrieval processes in episodic memory. Psychological Review, 80, 352-373.

van Meter, P. (2001). Drawing construction as a strategy for learning from text. Journal of Educational Psychology, 93, 129-140.

Varley, W. J., Levin, J. R., Severson, R. A., & Wolff, P. (1974). Training imagery production in young children through motor involvement. Journal of Educational Psychology, 66, 262-266.

Wolff, P., & Levin, J. R. (1972). The role of overt activity in children's imagery production. Child Development, 43, 537-547.

Woodcock, R. W. (1998). Woodcock reading mastery tests-revised. Circle Pines, Minn.: American Guidance Service.

We claim:

1. A method for improving reading comprehension by a subject having access to a physical representation of at least one scenario described in a text having a plurality of critical sentences and having access to a plurality of physical objects representing actors or objects in the at least one scenario, the method comprising the steps of:
reading the text for the at least one scenario; and
manipulating the relevant physical object or objects in the physical representation of the at least one scenario to act out the plurality of critical sentences in the text,
such that a comprehension benefit is realized.

2. A method as claimed in claim 1 wherein the manipulating step is practiced for each critical sentence in the text.

3. A method as claimed in claim 1 wherein the manipulating step is practiced in separate trials spaced apart in time for a plurality of scenarios described in a plurality of texts, such that a context-independent comprehension benefit is realized.

4. A method as claimed in claim 1 wherein the physical objects used in the method have realistic attributes relative to one another and to the physical representation of the scenario or scenarios.

5. A method as claimed in claim 1 wherein the subject is supervised by an instructor.

6. A method for improving reading comprehension by a subject, the method comprising the steps of:
reading at least one first text having a plurality of critical sentences for which the subject has access to a physical representation of a scenario described in the text and has access to a plurality of physical objects representing actors or objects in the scenario;
manipulating the relevant physical object or objects in the physical representation of the scenario in the at least one first text to act out the plurality of critical sentences,
reading at least one second text having a plurality of critical sentences for which the subject lacks access to a physical representation of a scenario described in the text and lacks access to a plurality of physical objects representing actors or objects in the scenario; and
imagining manipulating a relevant object or objects in an imagined representation of the scenario in the plurality of critical sentences of the at least one second text,
such that a transferred comprehension benefit is realized.

7. A kit comprising:
at least one text having a plurality of critical sentences, each text describing a scenario;
a physical representation of the scenario described in each text; and
a plurality of objects relevant to the scenario described in each text.

8. A kit as claimed in claim 7 wherein the text is provided in an electronic medium.

9. A kit as claimed in claim 7, the kit further comprising:
an instructor's guide.

10. A kit as claimed in claim 9 wherein the instructor's guide is provided in an electronic medium.
